(19) United States
(12) Patent Application Publication
(10) Pub. No.: US 2009/0120387 A1
(43) Pub. Date: May 14, 2009

(54) ENGINE EQUIPPED WITH COOLING WATER CHAMBER

(76) Inventor: Seung Dong Moon, Hwaseong-city (KR)

Correspondence Address: MORGAN, LEWIS & BOCKIUS LLP (SF), One Market, Spear Street Tower, Suite 2800, San Francisco, CA, 94105, US

(21) Appl. No.: 11/966,239

(22) Filed: Dec. 28, 2007

(30) Foreign Application Priority Data
Nov. 14, 2007 (KR) 10-2007-0116111

(51) Int. Cl. F02F 1/16; F02B 47/08; F01M 5/00

(52) U.S. Cl. 123/41.72; 123/568.12; 184/104.3

(57) ABSTRACT

An engine includes an engine block with at least one cylinder, configured for a piston to be provided therein. A wet liner is provided in the cylinder such that a gap is defined between the wet liner and the cylinder. The engine block defines a coolant inlet to transport a coolant to the gap, a coolant chamber, a coolant outlet to transport the coolant from the gap to the chamber, and a supply opening to transport the coolant from the chamber to an exhaust gas recirculation system.

### CROSS-REFERENCE TO RELATED APPLICATION

This application claims priority to, and the benefit of, Korean Patent Application No. 10-2007-0116111, filed in the Korean Intellectual Property Office on Nov. 14, 2007, the entire contents of which are incorporated herein by reference.

### BACKGROUND OF THE INVENTION

(a) Field of the Invention

The present invention relates to an engine with a coolant chamber to cool an exhaust gas recirculation system.

(b) Description of the Related Art

Many diesel engines in trucks or other heavy vehicles include exhaust gas recirculation systems, which return some of the exhaust gas exhausted from an engine to an intake device of a cylinder to lower combustion temperature of the engine, and to decrease NOₓ. A separate cooling system can be provided to cool the exhaust gas recirculation system, but the manufacturing cost if a separate cooling system is high. Further, the cooling system increases the engine volume.

The above information disclosed in this Background section is only for enhancement of understanding of the background of the invention and therefore it may contain information that does not form the prior art that is already known in this country to a person of ordinary skill in the art.

### SUMMARY OF THE INVENTION

An engine includes an engine block with at least one cylinder, configured for a piston to be provided therein. A wet liner is provided in the cylinder such that a gap is defined between the wet liner and the cylinder. The engine block defines a coolant inlet to transport a coolant to the gap, a coolant chamber, a coolant outlet to transport the coolant from the gap to the chamber, and a supply opening to transport the coolant from the chamber to an exhaust gas recirculation system.

A water pump may be provided on the engine block for supplying the coolant to the inlet.

An oil cooling apparatus may be provided between the water pump and the inlet.

### BRIEF DESCRIPTION OF THE DRAWINGS

FIG. 1 is a partial perspective view of an engine with a coolant chamber according to an exemplary embodiment of the present invention.

FIG. 2 is a partial cross-sectional view of the engine of FIG. 1.

### DETAILED DESCRIPTION OF PREFERRED EMBODIMENTS

The present invention will be described more fully hereinafter with reference to the accompanying drawings, in which exemplary embodiments of the invention are shown.

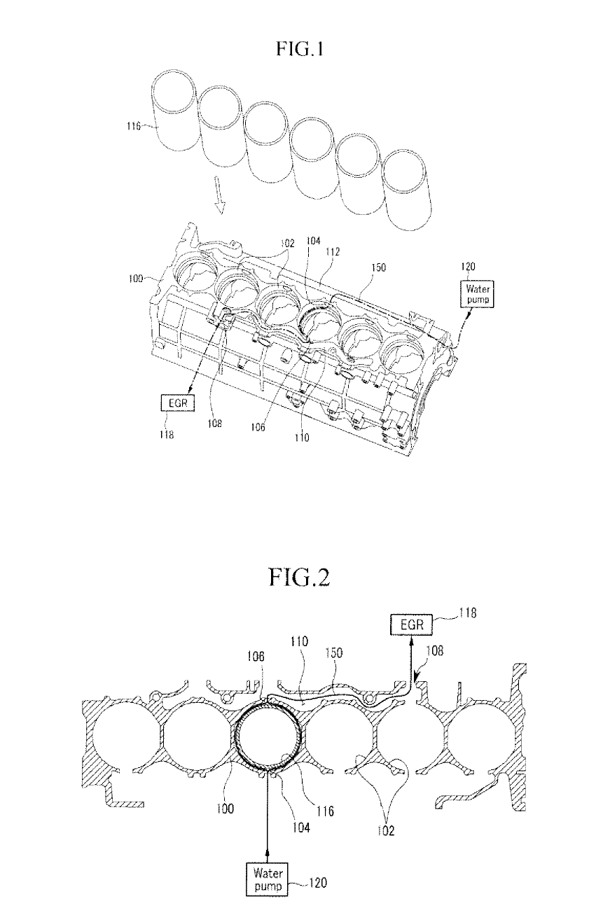

Referring to FIG. 1, six cylinders 102 are disposed in series in an engine block 100, and a wet liner 116 is provided in each cylinder 102. The inner side of the wet liner 116 contacts a piston (not shown).

A gap is defined between the inner side of the cylinder 102 and the exterior surface of the wet liner 116. Further, a coolant inlet 104 and a coolant outlet 106 are provided in the engine block 100.

An oil cooler 112 is provided in one side of the engine block 100 (upper side of FIG. 1), and a water pump 120 is provided in one side of the engine block 100 (right side of FIG 1).

A coolant chamber 110 is provided in the engine block 100 opposite the oil cooler 112. The coolant chamber 110 is in fluid communication with the outlet 106. Further, supply opening 108 is provided in the coolant chamber 110, and is connected to an exhaust gas recirculation (EGR) system 118.

The coolant flows along path 150 by way of the water pump 120. The coolant cools the oil cooler 112, the wet liner 116, and the EGR system 118 sequentially.

As shown in FIG. 2, the coolant that is supplied from the water pump 120 is supplied to the inlet 104 through the oil cooler 112. The coolant enters the cylinder 102 through the inlet 104, flows into the gap between the cylinder 102 and the wet liner 116, and is exhausted through the outlet 106 to the chamber 110. The coolant in the coolant chamber 110 is exhausted out through the supply opening 108, and then cools the EGR system 118.

The coolant chamber 110 can be integrally formed in the engine block 100, so the manufacturing cost and the volume of the engine are low.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An engine, comprising:
an engine block comprising at least one cylinder configured for a piston to be disposed therein; and
a wet liner disposed in the cylinder such that a passage is defined between the wet liner and the cylinder;
wherein the engine block defines a coolant inlet in fluid communication with the passage, a coolant chamber, a coolant outlet fluidly communicating the passage to the coolant chamber, and an EGR-supply opening fluidly communicating the coolant chamber to an exhaust gas recirculation system.

2. The engine of claim 1, further comprising a water pump disposed on the engine block for supplying the coolant to the inlet.

3. The engine of claim 2, further comprising an oil cooling apparatus disposed between the water pump and the inlet.

4. An engine block, comprising:
at least one cylinder configured for a piston and a wet liner to be disposed therein, such that a passage is defined between the wet liner and the cylinder;
a coolant inlet in fluid communication with the passage;
a coolant chamber;
a coolant outlet fluidly communicating the passage to the coolant chamber; and
an EGR-supply opening fluidly communicating the coolant chamber to an exhaust gas recirculation system.
